(19) United States
(12) Patent Application Publication
(10) Pub. No.: US 2011/0093163 A1
(43) Pub. Date: Apr. 21, 2011

(54) METHOD AND APPARATUS FOR DETECTING STEERING ANGLE SENSOR INITIALIZATION FAULT

(75) Inventor: Tae Wan BYUN, (US)

(73) Assignee: MANDO CORPORATION

(21) Appl. No.: 12/903,541

(22) Filed: Oct. 13, 2010

(30) Foreign Application Priority Data
Oct. 15, 2009 (KR) 10-2009-0098027

(51) Int. Cl. G06F 19/00

(52) U.S. Cl. 701/34

(57) ABSTRACT

Disclosed is a method and an apparatus for detecting a steering angle sensor initialization fault, which includes a steering angle sensor initialization detector for detecting a performance of initialization of a steering angle sensor of a vehicle, a straight drive determination unit for determining a straight drive state of the vehicle based on at least one of a steering angle speed, a torque, and a vehicle speed when the performance of the initialization has been detected, and a fault detector for detecting an offset angle of the steering angle sensor, determining if the offset angle is equal to or larger than a predetermined angle, and detecting a fault in the initialization of the steering angle sensor when the vehicle has been determined to be in the straight drive state. The method and the apparatus can detect the offset angle generated in the initialization of the steering angle sensor and detect the fault in the initialization of the steering angle sensor based on the detected offset angle, thereby effectively preventing occurrence of problems due to the fault in the initialization of the steering angle sensor.

### CROSS-REFERENCE TO RELATED APPLICATION

This application claims priority from and the benefit of Korean Patent Application No. 10-2009-0098027, filed on Oct. 15, 2009, which is hereby incorporated by reference for all purposes as if fully set forth herein.

### BACKGROUND OF THE INVENTION

1. Field of the Invention

The present invention relates to a method and an apparatus for detecting a steering angle sensor initialization fault. More particularly, the present invention relates to a method and an apparatus for detecting a steering angle sensor initialization fault, which can detect an offset angle generated in the initialization of a steering angle sensor and detect a fault in the initialization of the steering angle sensor based on the detected offset angle.

2. Description of the Prior Art

It is the recent trend that vehicles employ a Motor Driving Power Steering (MDPS) system for driving a motor by electronic control, which can make the steering power lighter at a low speed and make the steering power heavier at a high speed, thereby providing a high speed driving stability to a driver.

Such an MDPS system uses a steering angle sensor measuring an absolute steering angle. Meanwhile, when the steering angle sensor is initialized at a point separated from a center point after the initialization with respect to center point of the steering angle sensor, an offset angle of the steering angle sensor may be generated. The offset angle may greatly deteriorate a restoration performance of a steering wheel and incur a problem, such as a different steering sense, an overly sensitive operation of an Electric Stability Control (ESC) system of a vehicle, etc. Further, other modules receiving the steering angle for use take incorrect actions, so that a problem capable of threatening the safety of the driver may be incurred.

### SUMMARY OF THE INVENTION

Accordingly, the present invention has been made to solve the above-mentioned problems occurring in the prior art, and an object of the present invention is to provide an apparatus and a method for detecting a steering angle sensor initialization fault, which can detect an offset angle in the initialization of a steering angle sensor and detects a fault in the initialization of the steering angle sensor based on the detected offset angle, thereby preventing problems generated due to the fault in the initialization of the steering angle sensor.

In order to accomplish this object, there is provided an apparatus for detecting a steering angle sensor initialization fault, including: a steering angle sensor initialization detector for detecting a performance of initialization of a steering angle sensor of a vehicle; a straight drive determination unit for determining a straight drive state of the vehicle based on at least one of a steering angle speed, a torque, and a vehicle speed when the performance of the initialization has been detected; and a fault detector for detecting an offset angle of the steering angle sensor, determining if the offset angle is equal to or larger than a predetermined angle, and detecting a fault in the initialization of the steering angle sensor when the vehicle has been determined to be in the straight drive state.

In accordance with another aspect of the present invention, there is provided a method for detecting a steering angle sensor initialization fault, the method including the steps of: detecting initialization of a steering angle sensor, in which a performance of initialization of the steering angle sensor of a vehicle is detected; determining a straight drive, in which when the initialization of the steering angle sensor has been detected, a straight drive state of the vehicle is determined based on at least one of a steering angle speed, a torque, and a vehicle speed; and detecting a fault, in which when the vehicle has been determined to be in the straight drive state, an offset angle of the steering angle sensor is detected, it is determined if the detected offset angle is equal to or larger than a predetermined angle, and a fault in the initialization of the steering angle sensor is detected.

Accordingly, the present invention can detect the offset angle generated in the initialization of the steering angle sensor and detect the fault in the initialization of the steering angle sensor based on the detected offset angle, thereby effectively preventing occurrence of problems due to the fault in the initialization of the steering angle sensor.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating an apparatus 100 for detecting a steering angle sensor initialization fault according to an embodiment of the present invention;

FIG. 2 is a flow chart illustrating a method for detecting a steering angle sensor initialization fault according to an embodiment of the present invention; and

FIG. 3 is a detailed flow chart illustrating a method for detecting a steering angle sensor initialization fault according to an embodiment of the present invention.

### DETAILED DESCRIPTION OF THE PREFERRED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

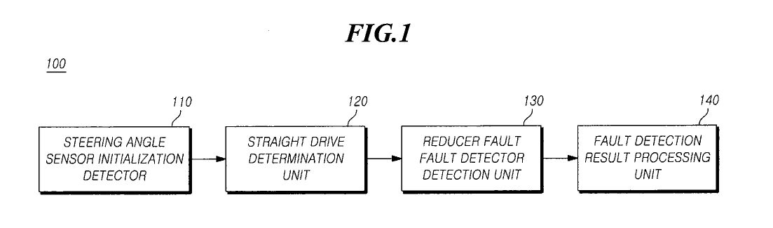

FIG. 1 is a block diagram illustrating an apparatus 100 for detecting a steering angle sensor initialization fault according to an embodiment of the present invention.

As illustrated in FIG. 1, the apparatus 100 for detecting the steering angle sensor initialization fault includes a steering angle sensor initialization detector 110, a straight drive determination unit 120, and a fault detector 130.

Referring to FIG. 1, the steering angle sensor initialization detector 110 included in the apparatus 100 for detecting the steering angle sensor initialization fault according to the embodiment of the present invention detects the initialization of the steering angle sensor of a vehicle. Here, the steering angle sensor can be referred to as an absolute angle sensor or an absolute steering angle sensor.

Referring to FIG. 1, the straight drive determination unit 120 included in the apparatus 100 for detecting the steering angle sensor initialization fault according to the embodiment of the present invention determines a straight drive state of a corresponding vehicle based on at least one of a steering angle speed, a torque, and a vehicle speed when the steering angle sensor initialization detector 110 has detected the initialization of the steering angle sensor.

Referring to FIG. 1, when the straight drive determination unit 120 has determined that the corresponding vehicle is in the straight drive state, the fault detector 130 included in the apparatus 100 for detecting the steering angle sensor initialization fault according to the embodiment of the present invention detects an offset angle of the steering angle sensor, determines if the detected offset angle is equal to or larger than a predetermined angle, and detects a fault in the initialization of the steering angle sensor.

The aforementioned straight drive determination unit 120 determines whether the corresponding vehicle satisfies a first condition that the steering angle speed is equal to or less than a reference steering angle speed, a second condition that a vehicle speed is equal to or larger than reference vehicle speed information, and a third condition that a torque is equal to or less than reference torque information and determines a straight drive state of the vehicle according to a determination result.

When the straight drive determination unit 120 has determined that the corresponding vehicle is in the straight drive state, the fault detector 130 detects an offset angle of the steering angle sensor at the time of the determination of the straight drive state of the vehicle and determines if the offset angle is equal to or larger than a predetermined angle. When the fault detector 130 has detected that the offset angle is equal to or larger than the predetermined angle, the fault detector 130 detects a fact that a fault (error) has occurred in the initialization of the steering angle sensor.

That is, when the straight drive determination unit 120 has determined that the corresponding vehicle is in the straight drive state, the fault detector 130 detects the offset angle that is a difference between a straight drive determination steering angle that is a steering value estimated in the determination of the straight drive and a steering value of the steering angle sensor. When the offset angle is larger than a threshold of the predetermined angle, the fault detector 130 detects that the fault has occurred in the initialization of the steering angle sensor.

Referring to FIG. 1, the apparatus 100 for detecting the steering angle sensor initialization fault according to the embodiment of the present invention further includes a fault detection result processing unit 140 which lights a warning light, stores a corresponding Diagnostic Trouble Code (DTC), or transmits a fault message with a steering angle CAN ID through a Controller Area Network (CAN) for a vehicle when the fault in the initialization of the steering angle sensor has been detected.

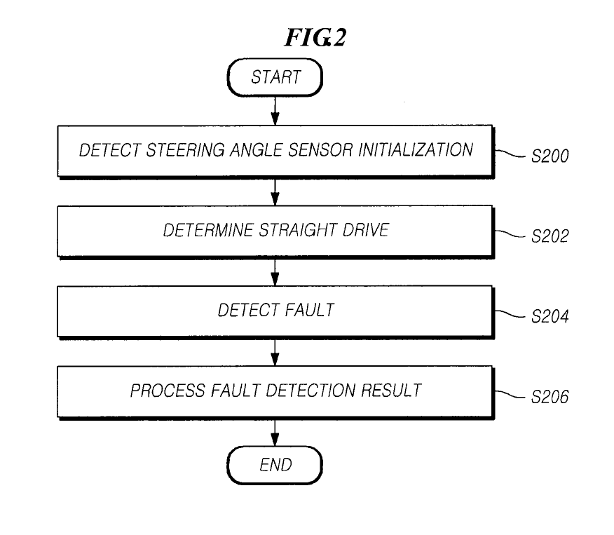

FIG. 2 is a flow chart illustrating a method for detecting a steering angle sensor initialization fault by the apparatus 100 for detecting the steering angle sensor initialization fault according to the embodiment of the present invention.

Referring to FIG. 2, the method for detecting the steering angle sensor initialization fault by the apparatus 100 for detecting the steering angle sensor initialization fault according to the embodiment of the present invention includes detecting a steering angle sensor initialization (S200), in which the performance of the initialization of the steering angle sensor of a vehicle is detected, determining a straight drive (S202), in which when the initialization of the steering angle sensor of the vehicle has been detected, a straight drive state of the corresponding vehicle is determined based on at least one of a steering angle speed, a torque, and a vehicle speed, and detecting a fault (S204), in which when it has been determined that the corresponding vehicle is in the straight drive state, an offset angle of the steering angle sensor is detected, it is determined if the detected offset angle is equal to or larger than a predetermined angle, and a fault in the initialization of the steering angle sensor is detected.

In the step S202 of determining the straight drive, it is determined if the corresponding vehicle satisfies at least one of a first condition that the steering angle speed is equal to or less than a reference steering angle speed, a second condition that a vehicle speed is equal to or larger than reference vehicle speed information, and a third condition that a torque is equal to or less than reference torque information, and the straight drive state of the vehicle is determined according to a determination result.

In the step S204 of detecting the fault, when the corresponding vehicle is determined to be in the straight drive state in the step S202 of determining the straight drive, the offset angle of the steering angle sensor at the time of the determination of the straight drive state of the vehicle is detected, it is determined if the offset angle is equal to or larger than a predetermined angle, and when it is determined that the offset angle is equal to or larger than a predetermined angle, a fact that a fault (error) has occurred in the initialization of the steering angle sensor is detected.

Referring to FIG. 2, the method for detecting the steering angle sensor initialization fault according to the embodiment of the present invention further includes processing a fault detection result (S206), in which when the fault in the initialization of the steering angle sensor has been detected in the step S204 of detecting the fault, a warning light is lightened, a corresponding Diagnostic Trouble Code (DTC) is stored, or a fault message is transmitted with a steering angle CAN ID through a Controller Area Network (CAN) for a vehicle.

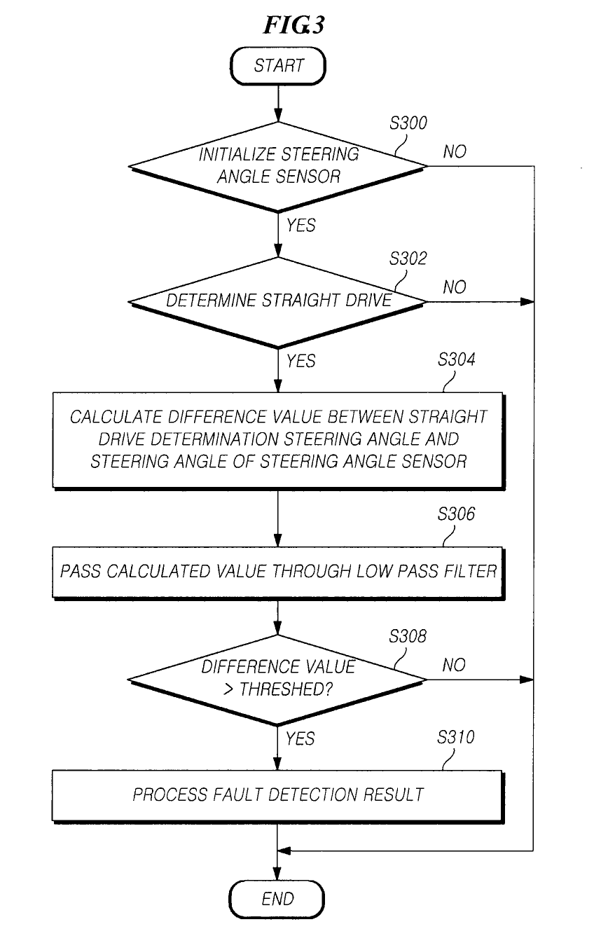

The aforementioned steering angle sensor initialization fault detecting method according to the embodiment of the present invention will be described with reference to FIG. 3 in more detail.

FIG. 3 is a detailed flow chart illustrating the method for detecting the steering angle sensor initialization fault according to the embodiment of the present invention.

Referring to FIG. 3, when the apparatus 100 for detecting the steering angle sensor initialization fault (also referred to as a ‘steering angle offset detecting apparatus’) starts the method for detecting the steering angle sensor initialization fault, it detects the performance of the initialization of the steering angle sensor of the vehicle (S300) and determines a straight drive state of the corresponding vehicle based on at least one of a steering angle speed, a torque, and a vehicle speed when the initialization of the steering angle sensor of the vehicle has been detected (S302). Then, when the corresponding vehicle has been determined to be in the straight drive state, the apparatus 100 for detecting the steering angle sensor initialization fault calculates a difference value between a straight drive determination steering angle that is a steering value estimated in the determination of the straight drive state and a steering value of the steering angle sensor (S304). Then, the apparatus 100 for detecting the steering angle sensor initialization fault passes the calculated difference value through a Low Pass Filter (LPF) (S306), and determines if the passed difference value (referred to as an offset angle) exceeds a predetermined threshold of a predetermined angle (S308). When the difference value exceeds the threshold, the apparatus 100 for detecting the steering angle sensor initialization fault detects that a fault has occurred in the initialization of the steering angle sensor, and then performs a fault detecting result process of lighting a warning light, storing a corresponding Diagnostic Trouble Code (DTC), or transmitting a fault message with a steering angle CAN ID through a CAN for a vehicle (S310).

The conventional MPDS system employs the steering angle sensor measuring an absolute steering angle. When the steering angle sensor is initialized at a point separated from a center point after the initialization with respect to center point of the steering angle sensor, an offset angle of the steering angle sensor may be generated. The offset angle may greatly deteriorate a restoration performance of a steering wheel and cause a problem, such as a different steering sense, an overly sensitive operation of an Electric Stability Control (ESC) system of a vehicle, etc. Further, other modules receiving the steering angle for use take incorrect actions, so that a problem capable of threatening the safety of the driver may be incurred.

In order to solve the aforementioned problems, the present invention according to the embodiment of the present invention detects the offset angle generated in the initialization of the steering sensor and detects the fault in the initialization of the steering angle sensor based on the detected offset angle, so that it is possible to prevent occurrence of the aforementioned problems due to the default in the initialization of the steering angle sensor.

Even if it was described above that all of the components of an embodiment of the present invention are coupled as a single unit or coupled to be operated as a single unit, the present invention is not necessarily limited to such an embodiment. That is, among the components, one or more components may be selectively coupled to be operated as one or more units. In addition, although each of the components may be implemented as an independent hardware, some or all of the components may be selectively combined with each other, so that they can be implemented as a computer program having one or more program modules for executing some or all of the functions combined in one or more hardware. Codes and code segments forming the computer program can be easily conceived by an ordinarily skilled person in the technical field of the present invention. Such a computer program may implement the embodiments of the present invention by being stored in a computer readable storage medium, and being read and executed by a computer. A magnetic recording medium, an optical recording medium, a carrier wave medium, or the like may be employed as the storage medium.

In addition, since terms, such as “including,” “comprising,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are not defined otherwise. A term ordinarily used like that defined by a dictionary shall be construed that it has a meaning equal to that in the context of a related description, and shall not be construed in an ideal or excessively formal meaning unless it is clearly defined in the present specification.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

What is claimed is:

1. An apparatus for detecting a steering angle sensor initialization fault, comprising:
a steering angle sensor initialization detector for detecting a performance of initialization of a steering angle sensor of a vehicle;
a straight drive determination unit for determining a straight drive state of the vehicle based on at least one of a steering angle speed, a torque, and a vehicle speed when the performance of the initialization has been detected; and
a fault detector for detecting an offset angle of the steering angle sensor, determining if the offset angle is equal to or larger than a predetermined angle, and detecting a fault in the initialization of the steering angle sensor when the vehicle has been determined to be in the straight drive state.

2. The apparatus as claimed in claim 1, wherein the straight drive determination unit determines if the corresponding vehicle satisfies a first condition that the steering angle speed is equal to or less than a reference steering angle speed, a second condition that the vehicle speed is equal to or larger than reference vehicle speed information, and a third condition that the torque is equal to or less than reference torque information, and determines a straight drive state of the vehicle according to a determination result.

3. The apparatus as claimed in claim 1, wherein when the vehicle has been determined to be in the straight drive state, the fault detection unit detects the offset angle that is a difference between a straight drive determination steering angle of a steering value estimated in the determination of the straight drive and a steering value of the steering angle sensor, and when the offset angle is larger than a threshold of the predetermined angle, the fault detection unit detects that the fault has occurred in the initialization of the steering angle sensor.

4. The apparatus as claimed in claim 1, further comprising a fault detection result processing unit for lighting a warning light, storing a corresponding Diagnostic Trouble Code (DTC), or transmitting a fault message with a steering angle CAN ID through a Controller Area Network (CAN) for a vehicle when the fault in the initialization of the steering angle sensor has been detected.

5. A method for detecting a steering angle sensor initialization fault, the method comprising the steps of:
detecting initialization of a steering angle sensor, in which a performance of initialization of the steering angle sensor of a vehicle is detected;
determining a straight drive, in which when the initialization of the steering angle sensor has been detected, a straight drive state of the vehicle is determined based on at least one of a steering angle speed, a torque, and a vehicle speed; and
detecting a fault, in which when the vehicle has been determined to be in the straight drive state, an offset angle of the steering angle sensor is detected, it is determined if the detected offset angle is equal to or larger than a predetermined angle, and a fault in the initialization of the steering angle sensor is detected.
